(19) United States
(12) Patent Application Publication
(10) Pub. No.: US 2016/0188809 A1
(43) Pub. Date: Jun. 30, 2016

(54) Method and Program Product for Healthcare Provider Reporting

(71) Applicant: Peter Papavaritis Legorburu, Miami, FL (US)

(72) Inventor: Peter Papavaritis Legorburu, Miami, FL (US)

(21) Appl. No.: 14/979,391

(22) Filed: Dec. 27, 2015

Related U.S. Application Data
(60) Provisional application No. 62/097,122, filed on Dec. 28, 2014.

(51) Int. Cl. G06F 19/00

(52) U.S. Cl. CPC G06F 19/322; G06F 19/327

(57) ABSTRACT

A method and program product include displaying an encounter form. The encounter form is at least configured for enabling entry of encounter data obtained during an encounter with a patient by a healthcare provider. The encounter data is captured. A quality reporting analysis is executed. The quality reporting analysis is at least operable for processing at least a portion of the encounter data with a quality reporting measure data and logic to produce quality measure reporting opportunities for the encounter. The quality measure reporting opportunities are displayed in the encounter form.

### CROSS-REFERENCE TO RELATED APPLICATIONS

The present Utility patent application claims priority benefit of the U.S. provisional application for patent Ser. No. 62/097,122 filed 28 Dec. 2014 entitled “SYSTEM AND METHOD FOR HEALTHCARE PROVIDER QUALITY REPORTING” under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to healthcare. More particularly, the invention relates to healthcare provider reporting.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is believed that many healthcare providers use data capture at the point of care and use of comprehensive Electronic Health Record (EHR) systems. It is believed that many providers elect to use a more traditional style of direct coding of patient encounters at the point of care by providers.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. A system and method describes a real-time charge capture-centralized conversation between billing and provider entities.

By way of educational background, another aspect of the prior art generally useful to be aware of is that a system and method allows for a user to create and edit a charge capture slip on an electronic device.

By way of educational background, another aspect of the prior art generally useful to be aware of is that a method, apparatus and system is disclosed for communicating healthcare information to and from a portable, hand-held device.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary computing environment, in accordance with an embodiment of the present invention;

FIG. 2 illustrates an exemplary logic flow, in accordance with an embodiment of the present invention;

FIG. 3 is illustrates an exemplary Electronic Encounter Form, in accordance with an embodiment of the present invention;

FIG. 4 illustrates exemplary data structures, in accordance with embodiments of the present invention;

FIG. 5-1, FIG. 5-2, and FIG. 5-3 illustrate an exemplary quality measure with criteria, in accordance with an embodiment of the present invention;

FIG. 6 illustrates a block diagram depicting a conventional client/server communication system; and

FIG. 7 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forward most point of the upper or outsole and the rearward most point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”, e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are solely by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combinations thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consist essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, ECMAscript, C, C#, C++, Smalltalk, Perl, Python, Typescript, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, executable code and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a mesh network; a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Many embodiments of the present invention, and variations thereof, disclose means and steps for a system, method, and program for the capture and transmission of encounter codes and quality reporting data using mobile computing devices. In many embodiments, the system may be used wherever healthcare is rendered or documented, including by way of example and without limitation, a hospital, a clinic, an emergency department, at a field location where emergency care is rendered such as at the site of an accident or home health emergency, a patient's place of residence such as in home health settings, or a healthcare provider's office. In many embodiments and variations thereof, a healthcare provider, using a mobile computing device such as, but not limited to, a mobile phone, tablet, laptop, etc., may open an Electronic Encounter Form such as, but not limited to, a PDF, HTML web form, NET application, etc., including, but not limited to, at least fields for entering or selecting identifying patient information, quality reporting codes, one or more of patient gender, date of birth, diagnosis codes, and procedure codes. The term healthcare provider as used herein may be interpreted as referring to either a healthcare service professional such as, without limitation, a nurse, emergency medical technician, medical doctor, physical therapist, psychologist, mental health counselor or to a healthcare scribe or medical scribe tasked with assisting such a healthcare provider in the documentation of aspects of patient encounters before, during, or after the providing of a healthcare service to a patient. In some embodiments, patient demographic data on the Electronic Encounter Form may be entered into the Electronic Encounter Form by the healthcare provider by one of manual data entry, selecting a patient from a pre-populated list of patients previously transferred to the mobile computing device and made available within the electronic encounter form, or requesting patient demographics from a remote server based on patient identifying information entered by the healthcare provider into a subset of the demographics fields present on the electronic encounter form. In some embodiments, Quality Reporting Software within the Electronic Encounter Form communicates with a Quality Measure Server and requests a Quality Reporting Measure Data & Logic. In some embodiments, with the click of a single button on the Electronic Encounter Form, a healthcare provider may submit data entered into the Electronic Encounter Form, transmitting patient data and encounter data, including, without limitation, one or more of at least one diagnosis code or at least one procedure code, and Quality Reporting Data to an Encounter Data Server and transmitting said Quality Reporting Data and Quality Reporting Decision Data to a Quality Data Server.

In some embodiments, the Quality Reporting Software within the Electronic Encounter Form may submit patient identifying information to the Quality Measure Server in order to obtain, in addition to Quality Reporting Measure Data & Logic, a Quality Measure Reporting Summary for the patient including, without limitation, at least the list of measures captured during the applicable reporting period, dates reported, and measure reporting frequency requirements. The Quality Reporting Software may then visually indicate to the healthcare provider via a window within the Electronic Encounter Form graphical interface such as, but not limited to, by special coloring, items on the list of Quality Measure Reporting Opportunities for the current encounter that represent reporting opportunities for which the reporting requirement has been met during the applicable reporting period.

Some embodiments may have an Electronic Encounter Form displaying on a mobile device and designed to capture and/or display at least patient ID, gender, age or date of birth, diagnosis code(s), and procedure code(s), delivered by a server with integrated Quality Reporting Software such as, but not limited to, implemented as JavaScript within an HTML Electronic Encounter Form that highlights potential quality reporting opportunities consistent with the data entered in the form by the healthcare provider.

Some embodiments may have an Electronic Encounter Form designed to capture and/or display at least patient ID and at least one of diagnosis code(s) and procedure code(s) delivered to a device or resident on a device. A healthcare provider may create an interim or final submission of form data which is sent to a Quality Reporting Server process running on a server such as, without limitation, JavaScript running on a NodeJS server, which returns potential quality reporting opportunities for display, and which remote Quality Reporting Server process may optionally have the ability to pull additional patient demographics, diagnosis, or treatment information that may be used to more effectively determine measure applicability by integrating additional information not necessarily available on the client device.

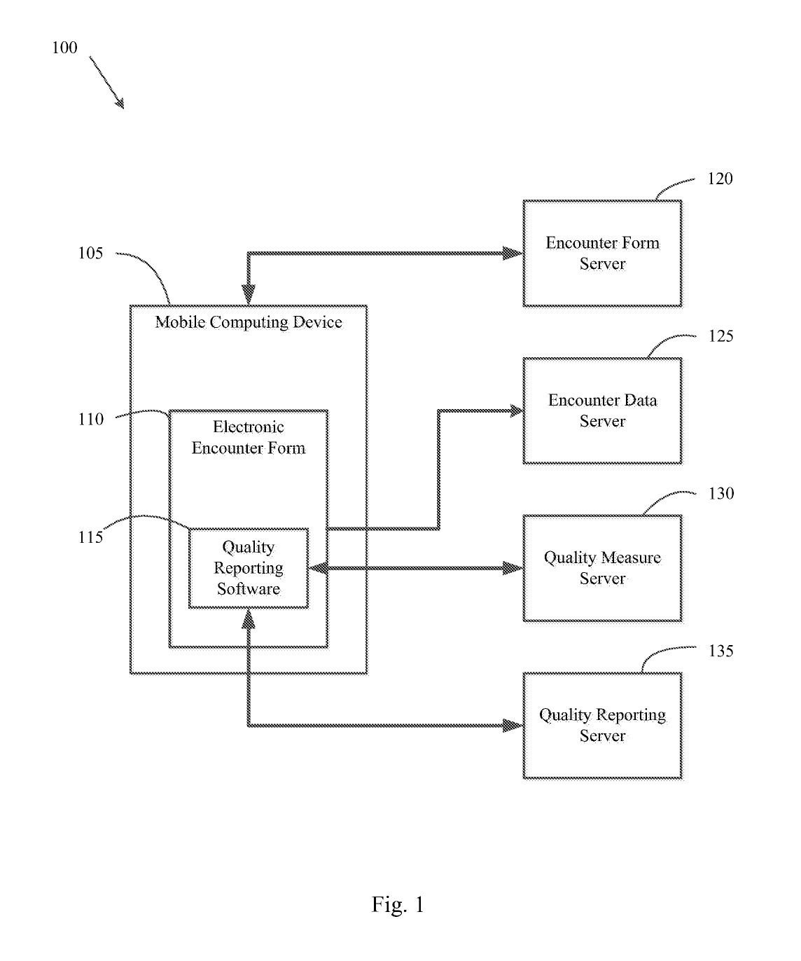

FIG. 1 illustrates an exemplary computing environment, in accordance with an embodiment of the present invention. In the present embodiment, a system 100 may include a healthcare provider Mobile Computing Device 105 which may be capable of downloading an Electronic Encounter Form 110 from an Encounter Form Server 120. In some embodiments, the healthcare provider may use Mobile Computing Device 105 to request Electronic Encounter Form 110 from Encounter Form Server 120. Encounter Form Server 120 may transfer Electronic Encounter Form 110 using for example, without limitation, HTTP or HTTPS web services, FTP or SFTP file transfer services, or any other means for transferring of data over a local area network, wide area network, or the Internet from the Encounter Form Server 120.

Electronic Encounter Form 110 may be implemented using any technology that may execute a Quality Reporting Software 115 implemented using an embedded scripting code, such as, but not limited to, JavaScript™ or TypeScript, and may permit the embedded scripting code to establish a connection to a network service. In a non-limiting example, either an Adobe PDF™ document opened under Adobe Acrobat Reader™ or an HTML/JavaScript™ document opened using a web browser with JavaScript support may be both technologies that may be used to create Electronic Encounter Form 110.

Mobile Computing Device 105 may include, without limitation, a Windows™-based tablet PC, a Windows™-based laptop, an Apple iPhone™, an Apple iPad™, an Android™-based tablet, an Android™-based mobile phone, a portable virtual reality headset with hand tracking, and more generally any portable device capable of opening the Electronic Encounter Form 110. Electronic Encounter Form 110 may be implemented using any document technology intended to provide compatibility with many operating systems, and is contemplated to be within the scope of the present invention.

In the present embodiment, Quality Reporting Software 115 may request a Quality Reporting Measure Data & Logic from a Quality Measure Server 130 over, without limitation, a LAN, WAN, or Internet connection. Quality Measure Server 130 may return Quality Measure Data & Logic which enables Quality Reporting Software 115 to identify Quality Reporting Opportunities based on the data entered by the healthcare provider into the Electronic Encounter Form 110.

In some embodiments, the healthcare provider may manually trigger the identification of Quality Reporting Opportunities by the Quality Reporting Software 115 based on data entered in the Electronic Encounter Form 110. In some other embodiments, Quality Reporting Software 115 may be triggered to identify Quality Reporting Opportunities automatically by Electronic Encounter Form 110 each time data potentially relevant to the identification of Quality Reporting Opportunities by the Quality Reporting Software 115 changes. By way of example, but without limitation, the Physician Quality Reporting System of the Center for Medicare Services defines some quality measure reporting opportunities that may be applicable to a healthcare provider-patient encounter based on a combination of one or more of the reporting year, patient age at the time of encounter, patient gender, encounter diagnosis codes (International Classification of Disease Codes), and codes for procedure rendered during the encounter (Current Procedural Terminology Codes). To further extend this illustrative example, if a given measure may apply to all encounters with a patient of at least 18 years of age at the time of the encounter, on the healthcare provider's entering the patient's date of birth in Electronic Encounter Form 110 Quality Reporting Software 115 may add the corresponding measure to a list displayed within a portion of Electronic Encounter Form 110 toward making the healthcare provider aware of the opportunity to enter relevant quality code information based on information available at the time of the healthcare provider-patient encounter. It will be obvious to a practitioner skilled in the art that field validation logic and data, by way of example and without limitation, field validation logic and data that leverages one or more of a list of valid diagnosis codes, valid procedure codes, valid quality reporting codes, valid gender values may be used to ensure that a healthcare provider does not enter invalid codes or values as may be applicable to a given field on an Electronic Encounter Form.

In some embodiments, the process of automatically or manually triggering the identification of Quality Reporting Opportunities by the Quality Reporting Software 115 may be repeated as needed as data is entered into the Electronic Encounter Form 110 prior to submitting data via the Electronic Encounter Form 110 to an Encounter Data Server 125.

In some embodiments, Quality Reporting Software 115 may, in addition to presenting a list of Quality Reporting Opportunities, present the healthcare provider with a list of Quality Reporting Codes such as, without limitation, Current Procedural Terminology Category II (CPT II) codes and other codes specified for reporting of Physician Quality Reporting System (PQRS) quality measures by the Center for Medicare Services (CMS) which may be selected for entry or manually entered into Electronic Encounter Form 110 corresponding to each Quality Reporting Opportunity identified by Quality Reporting Software 115.

In the present embodiment, Quality Reporting Software 115 may transmit a request to a Quality Reporting Server 135 including, but not limited to, at least patient identifying data and a request for a list of quality measures, the reporting requirements for which have already been satisfied as of the date of patient-provider encounter, whereby Quality Reporting Server 135 may transmit to Quality Reporting Software 115 the list, the list being used by Quality Reporting Software 115 to visually indicate to the healthcare provider which Quality Reporting Opportunities displayed within Electronic Encounter Form 110 may represent an opportunity to report a quality measure for which the minimum requirements for reporting of the corresponding measure have been met for the subject patient and provider, and/or encounter date. The data submitted to Encounter Data Server 125 may include, but not limited to, healthcare provider identifying data, patient data and encounter data, including at least information identifying the patient such as, but not limited to, using patient name and date of birth, medical record number, social security number, or insurance plan and insurance identifier, zero or more diagnosis codes, zero or more procedure codes and zero or more codes representing Quality Reporting Data. At the time of final submission of Electronic Encounter Form 110 by the healthcare provider Quality Reporting Software 115 may transmit healthcare provider identifying data, patient identifying data, Quality Reporting Data and Quality Reporting Opportunity data to a Quality Reporting Server 135.

A Quality Reporting Opportunity is defined here as a quality measure that meets the criteria for being reported for a given encounter based on the data entered in Electronic Encounter Form 110, irrespective of whether or not a quality reporting code available for reporting the quality measure is actually reported via Electronic Encounter Form 110.

Quality Reporting Data is defined as the set of quality reporting codes recorded for quality measures captured for the encounter documented via Electronic Encounter Form 110.

Although in FIG. 1 the Encounter Form Server 120, Quality Measure Server 130, Encounter Data Server 125, and Quality Reporting Server 135, are visually represented as distinct, it will be obvious to a person of ordinary skill in the art that each server may be implemented as one or more software services. As a non-limiting example, these may be hardware-, virtual-machine, or cloud-hosted web services in the case of Quality Measure Server 130, Encounter Data Server 125, and Quality Reporting Server 135, and a web server such as Apache, Microsoft IIS, or a cloud-hosted web service solution such as Azure Web Sites in the case of the Encounter Form Server 120. It will be obvious to a person of ordinary skill in the art that the function of any given server may be implemented across multiple physical or virtual servers for security, reliability and/or performance reasons such as, without limitation, for protection of user logins with technologies for multi-factor authentication of users or for web server and database fail-over and load balancing, using commonly available technologies, and that such implementation details common to many server-based and web-based solutions fall within the scope of the invention. In some embodiments, the servers may share a database or leverage separate databases implemented using one or more commonly available relational or object database technologies.

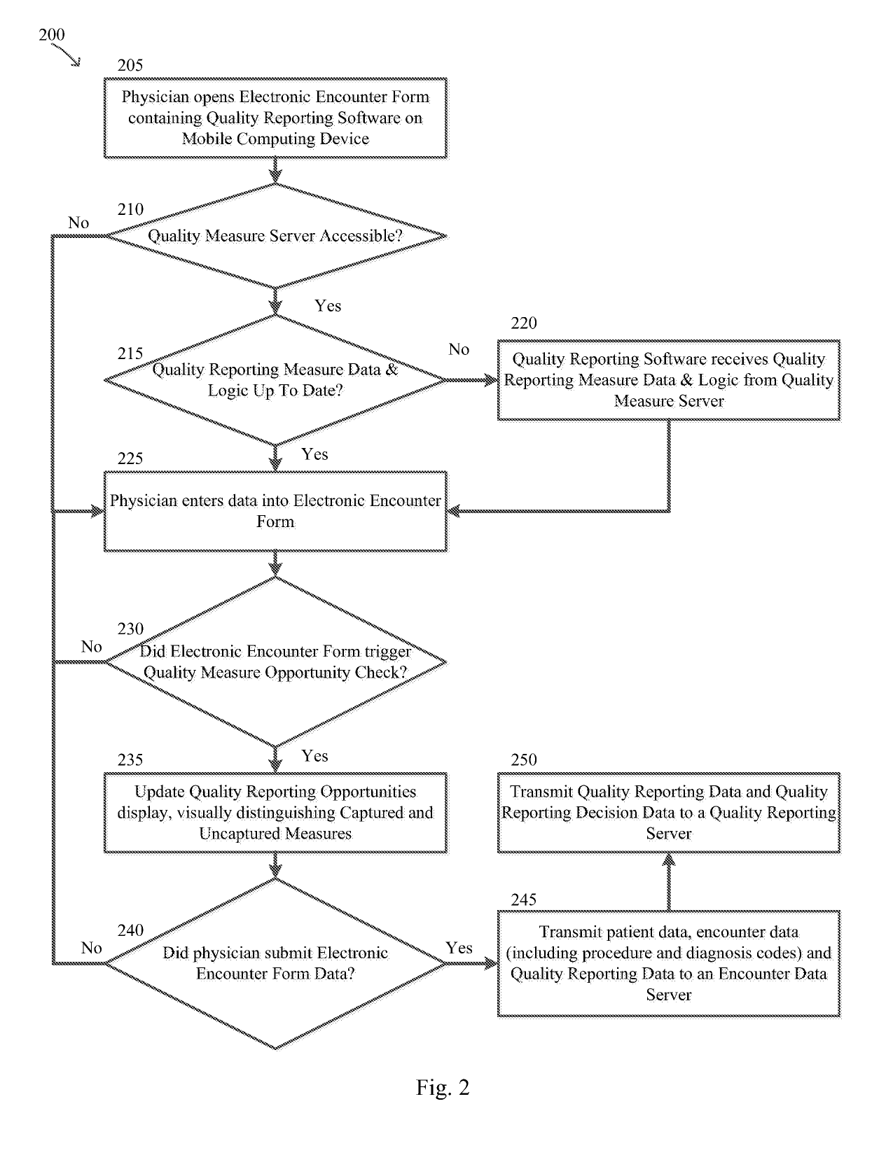

FIG. 2 illustrates an exemplary logic flow, in accordance with an embodiment of the present invention. In the present embodiment, Electronic Encounter Form 110 and Quality Reporting Software 115 may be running on healthcare provider Mobile Computing Device 105. In a step 205, a healthcare provider may open an Electronic Encounter Form 110. The Electronic Encounter Form 110 may be implemented using a document type and corresponding document rendering technology at least capable of, without limitation, (1) submitting via a network connection to an Encounter Data Server 125 or storing locally for later synchronization to Encounter Data Server 125 data entered into the Electronic Encounter Form 110 by a healthcare provider, and (2) capable of hosting Quality Measure Data and Logic and executing Quality Measure Logic implemented via a general-purpose programming language such as, but not limited to, JavaScript or Typescript. Two representative examples of such document rendering technology include, without limitation, Adobe PDF forms opened under Adobe Acrobat Reader and HTML documents opened under nearly any web browser including, but not limited to, Internet Explorer, Safari, Firefox, and Chrome. In an optional step 210, Quality Reporting Software 115 executing within Electronic Encounter Form 110 may attempt to communicate with Quality Measure Server 130. If the Quality Reporting Software 115 is unable to connect to a Quality Measure Server 130, the Quality Measure Logic may operate with Quality Measure Data cached by the Quality Reporting Software 115 and the healthcare provider may proceed with entry of data into Electronic Encounter Form 110 as shown in a step 225. In a step 215, if a Quality Measure Server 130 is accessible to the Quality Reporting Software 115, the Quality Reporting Software 115 may send locally available Quality Reporting Data & Logic version information to the Quality Reporting Server 135. If the locally available Quality Measure Data & Logic is up to date the healthcare provider may proceed with entry of data into the Electronic Encounter Form 110 as shown in step 225. If the Quality Measure Data & Logic are not up to date, the Quality Reporting Software 115 may optionally receive updated Quality Reporting Measure Data & Logic from the Quality Measure Server 130 in a step 220.

Step 225 may be representative of the state of the Electronic Encounter Form 110 in which the form is accepting of healthcare provider data entry; the sequence of steps outlined in FIG. 2 may unfold in a different order and the state represented in step 225, representing provider data entry into the Electronic Encounter Form 110, may continue to operate while other logic is executed.

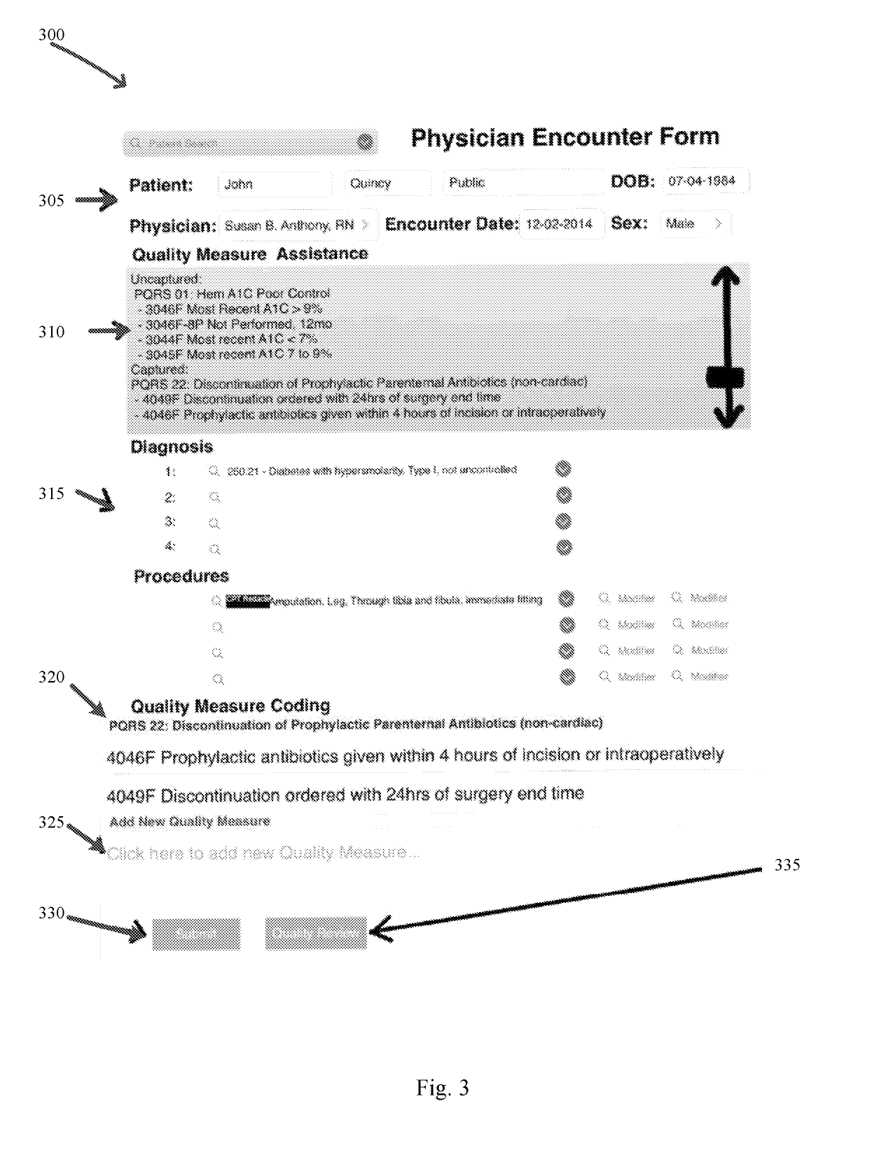

In a step 230, the Electronic Encounter Form 110 may respond to a trigger of a check of Quality Reporting Opportunities. In some embodiments, the check of Quality Reporting Opportunities may be triggered manually, as shown in FIG. 3, button 335. In some embodiments, the check of Quality Reporting Opportunities may be triggered automatically based on data entry events generated by the entry or editing of data fields in the Electronic Encounter Form 110, as shown in FIG. 3, sections 305 and 315. While a check of Quality Reporting Opportunities by the Quality Reporting Software 115 is not triggered, form data entry may proceed as illustrated by step 225. On triggering a Quality Reporting Opportunity Check, Electronic Encounter Form 110 may submit data including, but not limited to, one or more of patient gender, patient date of birth, encounter date, procedure codes, diagnosis codes and quality measure reporting codes, as shown in FIG. 3, sections 305, 315 and 320.

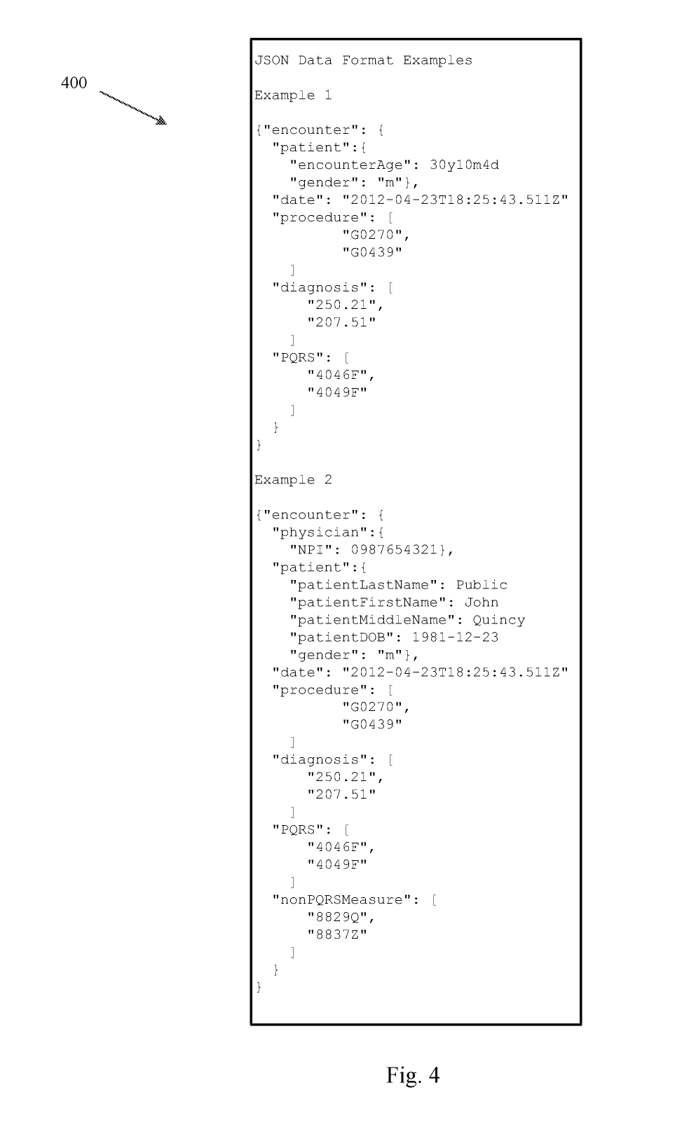

In a step 235 Quality Reporting Software 115 may then update the Quality Reporting Opportunity display section, as shown in FIG. 3, section 310, of the Electronic Encounter Form 110 to reflect at least, without limitation, captured, as shown in FIG. 3, sections 320, or uncaptured, as shown in FIG. 3, sections 310, quality measures based on the data provided by the Electronic Encounter Form 110 to the Quality Reporting Software 115 using a data structure such as, without limitation, one of the structures shown in FIG. 4.

In an optional step 240, if the healthcare provider submits the encounter data entered into the Electronic Encounter Form 110, such as, without limitation, by pressing a button 330, shown in FIG. 3, on the Electronic Encounter Form 110, the Electronic Encounter Form 110 may transmit, in an optional step 245, the encounter data including, without limitation, patient identifying information and one or more of diagnosis codes, procedure codes, Quality Reporting Data including quality reporting codes, and healthcare provider identifying information to Encounter Data Server 125. In an optional step 250 Quality Reporting Software 115 may transmit Quality Reporting Data including quality reporting codes, as shown in FIG. 3, section 320, and Quality Reporting Decision Data, as shown in FIG. 3, section 310, to the Quality Reporting Server 135. If instead of submitting the Electronic Encounter Form 110 the healthcare provider may continue to enter data into the Electronic Encounter Form 110 without submitting the form data, the process of identifying and displaying Quality Reporting Opportunities based on the updated data may be repeated based on the triggering of additional Quality Reporting Opportunity Checks. It will be obvious to a practitioner skilled in the art that submitted form data or partially completed form entries may be locally or remotely stored, and later retrieved for further editing and processing as contemplated by the present invention. In some embodiments, step 235 may optionally further include an action of adding details of Quality Reporting Opportunities displayed to the healthcare provider via an Electronic Encounter Form 110, see for example FIG. 3, section 310, to a compilation of Quality Reporting Opportunities maintained for a specific patient encounter being documented via the Electronic Encounter Form 110, the compilation may be submitted as Quality Reporting Decision Data to a Quality Reporting Server 135 as documentation of the quality reporting opportunities presented to the healthcare provider in the process of documenting a patient encounter. In some embodiments the Quality Reporting Decision Data may, without limitation, be combined with Quality Reporting Data and utilized to assess an individual healthcare provider's compliance with an organization's quality reporting policies.

FIG. 3 is illustrates an exemplary Electronic Encounter Form, in accordance with an embodiment of the present invention. It is contemplated that the style and format of an actual Electronic Encounter Form 300 may typically vary widely from medical practice to medical practice and sometimes even from provider to provider within a practice. Non-limiting examples of variations in design may include the use of different field types, including without limitation radio buttons, checkboxes, drop-down lists and radial menus for entry of coded or standardized elements such as, but not limited to, 315, 320, and 325, different fields and field types for capture of patient and healthcare provider identifying information and basic encounter data 305, and different visual component types such as, without limitation, one of formatted text box, modal dialog box, or unformatted text box for displaying Quality Reporting Opportunity Data 310. Section details and the order in which document sections appear within the Electronic Encounter Form 300 may all be varied within the scope of the present invention. Section 305 is a representative example of a portion of the Electronic Encounter Form 300 used to enter, without limitation, identifying patient, healthcare provider, and encounter information. Additional information gathered in this section may include, without limitation, information regarding the location of the encounter. Additionally, certain fields present in section 305 of the representative embodiment may be absent in or captured implicitly. One non-limiting example of a field shown in 305 which may be captured implicitly is the “Physician” field, as with some embodiments the healthcare provider identity may be captured when the healthcare provider logs in to a system which delivers the Electronic Encounter Form 110 document to the Mobile Computing Device 105. As an alternative to a healthcare provider's manually entering a patient identifier and patient demographic information in the Electronic Encounter Form, it will be obvious to a practitioner skilled in the art that alternative means of entering patient identifying data and/or demographics information, including by way of example but without limitation, the scanning of a patient ID bracelet, may be used to reduce the data entry burden on the healthcare provider while increasing data entry accuracy.

It will be obvious to a person of ordinary skill in the art that any field value may be similarly captured implicitly including, without limitation, as either a hidden field with a fixed value present on the Electronic Encounter Form 300, as a session variable such as, but not limited to, a cookie, maintained within the software hosting the Electronic Encounter Form 300, or as a server-side session variable maintained on at least one of an Encounter Form Server 120, a Quality Measure Server 130, an Encounter Data Server 125, and a Quality Reporting Server 135.

In the present embodiment, section 310 is a representation of a Quality Measure Assistance Display. The Quality Reporting Software 115 may update entries in a Quality Measure Assistance Display 310 after being triggered to run a Quality Reporting Opportunity Check. Listings in a Quality Measure Assistance Display 310 may include listings for a collection of quality measure reporting opportunities that have been captured, which is to say quality measures for which the healthcare provider has entered quality codes 320 on the Electronic Encounter Form 300. Additionally, entries in the Quality Measure Assistance Display 310 may include listings generated by the Quality Reporting Software 115 for quality measures that may have not been captured in the Quality Measure Coding Area section 320 for which Quality Reporting Opportunities have been identified by the Quality Reporting Software based on data entered by the healthcare provider into the Electronic Encounter Form 300. Additionally (not shown in FIG. 3) in some embodiments other entries may represent quality reporting opportunities for quality measures that are uncaptured within the Electronic Encounter Form 300 but for which reporting requirements have already been met based on prior quality reporting activities.

In the present embodiment, section 315 of the sample representative Electronic Encounter Form 300 presented in FIG. 3 is a representation of a General Coding Area which may be used by the healthcare provider to enter diagnosis code, procedure code, and procedure modifier code data to characterize a patient's diagnoses and services rendered to the patient within an embodiment of the invention. It will be obvious to a person of ordinary skill in the art that embodiments that support other data fields that may be relevant to characterizing a patient encounter or identifying Quality Reporting Opportunities including, without limitation, fields for medications provided to the patient, medical orders, and codes that define pre-defined groupings of diagnosis and procedure codes, may trivially be added to an Electronic Encounter Form 300; such variations are within the scope of the present invention.

In FIG. 3, section 320 illustrates a Quality Measure Coding Display Area of the simplified illustration of Electronic Encounter Form 300, which may display quality reporting codes entered by the healthcare provider. In some embodiments, the Quality Measure Code Display Area 320 may additionally group a set of one or more quality measure codes entered by the healthcare provider, and corresponding to a quality measure, under an entry for the quality measure including at least one of a code identifying the quality measure and a description of the quality measure.

In some embodiments, the Quality Measure Code Display Area 320 may be distinct from the General Coding Area 315, while in other embodiments, quality measure codes may be entered by the healthcare provider in a procedure code entry field in the General Coding Area 315 and a distinct Quality Measure Coding Area 320 may not be present. Section 325 in FIG. 3 illustrates an area that the healthcare provider may activate, without limitation, by touching, clicking with a pointing device such as a digitizer or mouse, selecting with a keyboard, or using eye tracking, as may be appropriate to the specific Mobile Computing Device 105 used by the healthcare provider to execute code for adding quality measure reporting code data corresponding to a quality measure.

Element 330 in FIG. 3 illustrates an area that the healthcare provider may activate, without limitation, by touching, clicking with a pointing device such as a digitizer or mouse, selecting with a keyboard, or using eye tracking, as may be appropriate to the specific Mobile Computing Device 105 used by the healthcare provider, to activate code in the Electronic Encounter Form 300 to transmit data to an Encounter Data Server 125 and transmit data to a Quality Reporting Server 135 as described in the detailed description of FIG. 2. In some alternate embodiments, if an error in the data is detected the transmission may be inhibited and the healthcare provider is alerted.

Element 335 in FIG. 3 illustrates an area that the healthcare provider may activate, without limitation, by touching, clicking with a pointing device such as a digitizer or mouse, selecting with a keyboard, or using eye tracking, as may be appropriate to the specific Mobile Computing Device 105 used by the healthcare provider, to manually trigger a Quality Reporting Opportunity Check as described in the detailed description of FIG. 2. In some alternate embodiments, if an error in the data is detected the manual trigger may be inhibited and the healthcare provider is alerted.

FIG. 4 illustrates exemplary data structures, in accordance with embodiments of the present invention. Examples 400 provides, without limitation, two different examples of data structures that may be used in an embodiment to submit data to a Quality Reporting Software 115 for a Quality Reporting Opportunity Check at step 230 (FIG. 2). Although in FIG. 4 the sample data structures are populated with specific data including specific patient name, specific provider names, specific codes, etc., in practical use it will be obvious to the person of ordinary skill in the art that at step 230 data structures would be populated with specific data corresponding to the values present in the Electronic Encounter Form 300.

In some embodiments, the data structures shown in the example in FIG. 4 may be implemented using JavaScript Object Notation (JSON) to support providing a Quality Reporting Software 115 implementation with the information needed to identify and characterize quality measure reporting opportunities for Physician Quality Reporting System (PQRS) claim-reportable measures based on the data submitted to the Quality Reporting Software 115 using said data structures.

It will be obvious to a person of ordinary skill in the art that in other embodiments data structures may be altered or augmented as required to support different data processing languages or additional types of data elements such as, but not limited to, what may be required for identification of opportunities to report a broad variety of quality measures based on the data submitted using the altered or augmented structures.

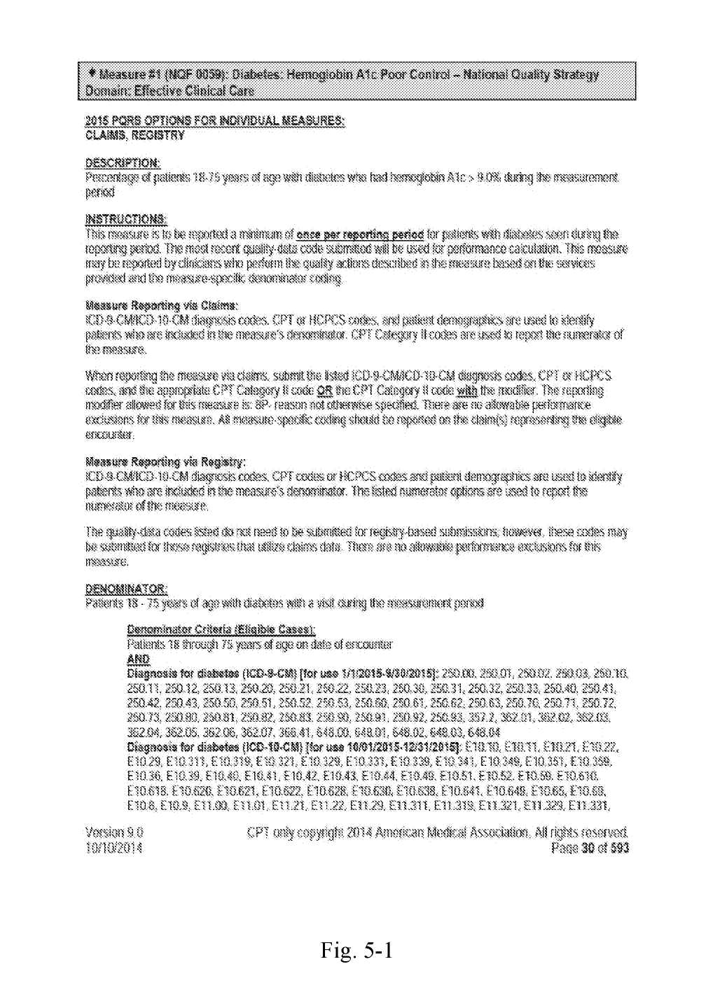

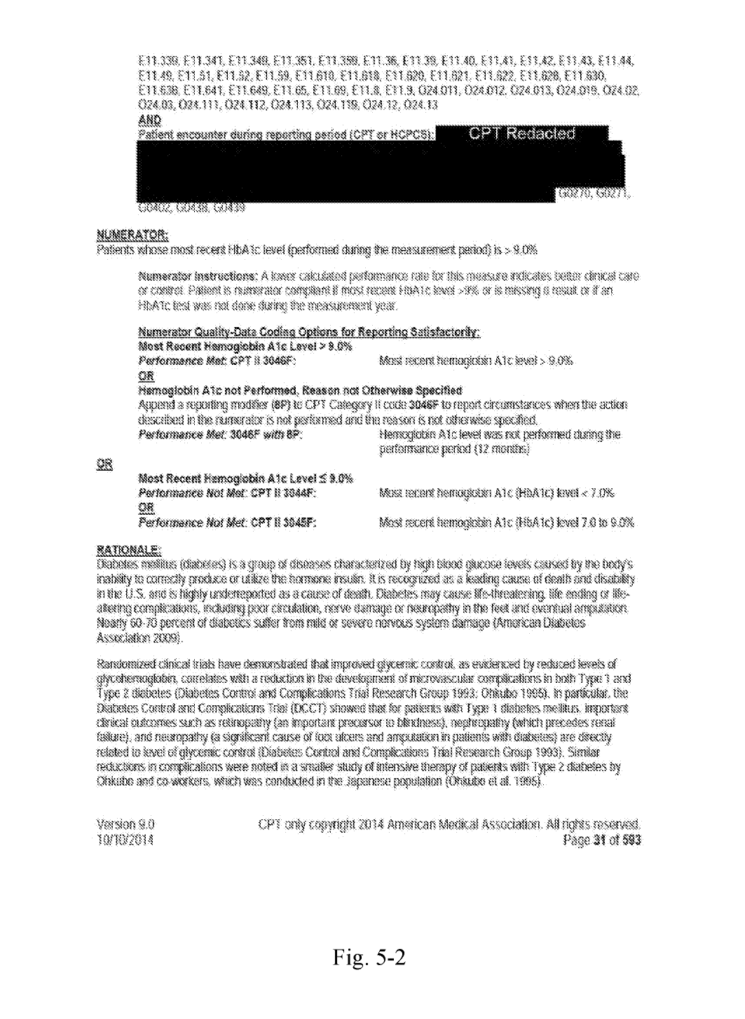

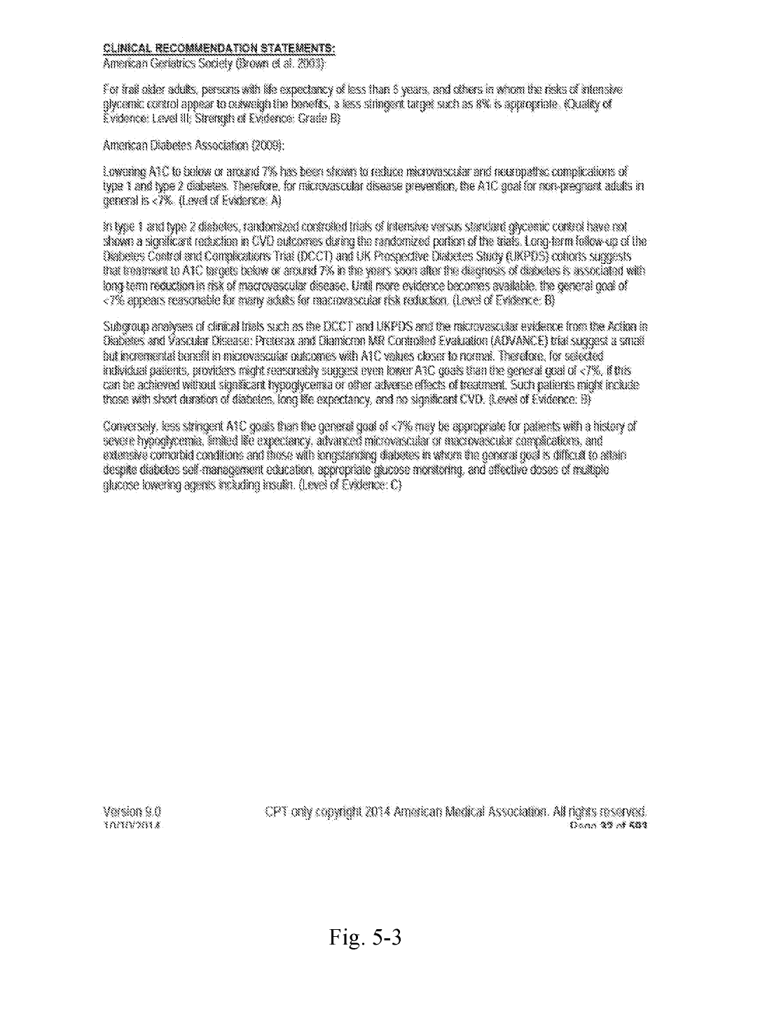

FIG. 5-1, FIG. 5-2, and FIG. 5-3 illustrate an exemplary quality measure with criteria, in accordance with an embodiment of the present invention. FIG. 5-1, FIG. 5-2, and FIG. 5-3 jointly contain a single illustrative example, without limitation, of a specific quality measure along with criteria for determining applicability of the quality measure to a patient encounter. The specific quality measure presented in FIGS. 5-1, 5-2, and 5-3, 2015 PQRS Measure #1, is one of several hundred measures that make up the 2015 PQRS measure set. Although FIGS. 5-1, 5-2, and 5-3 represent an example of a single one of many measures that might be simultaneously supported for the display of Quality Reporting Opportunities in step 230 in some embodiments, and specifically an example drawn from the 2015 PQRS measures, it will be apparent to a person of ordinary skill in the art that any quality measure system which bases assessment of qualification for capture of a measure on structured data that might be captured via an Electronic Encounter Form 300 may be supported by the present invention.

In the non-limiting example presented in FIGS. 5-1, 5-2, and 5-3, as is common in the description of many quality reporting measures, the “Reporting Denominator” requirements refer the criteria for the identification of “eligible cases”, which is to say cases which present Quality Reporting Opportunities. In the non-limiting example of FIGS. 5-1, 5-2, and 5-3, the denominator criteria used to identify Quality Reporting Opportunities within the Quality Reporting Software 115 are a combination of patient age at the time of encounter, patient diagnosis recorded during the encounter, and procedure rendered during the encounter as shown in FIG. 5-1.

In the non-limiting example presented in FIGS. 5-1, 5-2, and 5-3, as is common in the description of many quality reporting measures, the “Reporting Numerator” description provides quality data coding information describing the reportable codes for the quality measure—that is to say, codes used to report a measurement of the quality measure, including, without limitation, one of performing a quality action, not performing a quality action, or determining that an encounter should be excluded from eligibility, including, without limitation, for clinical reasons, which may be transmitted as Quality Reporting Data to the Quality Reporting Server 135 in step 250 as illustrated in FIG. 2 or to the Encounter Data Server in step 245 as illustrated in FIG. 2.

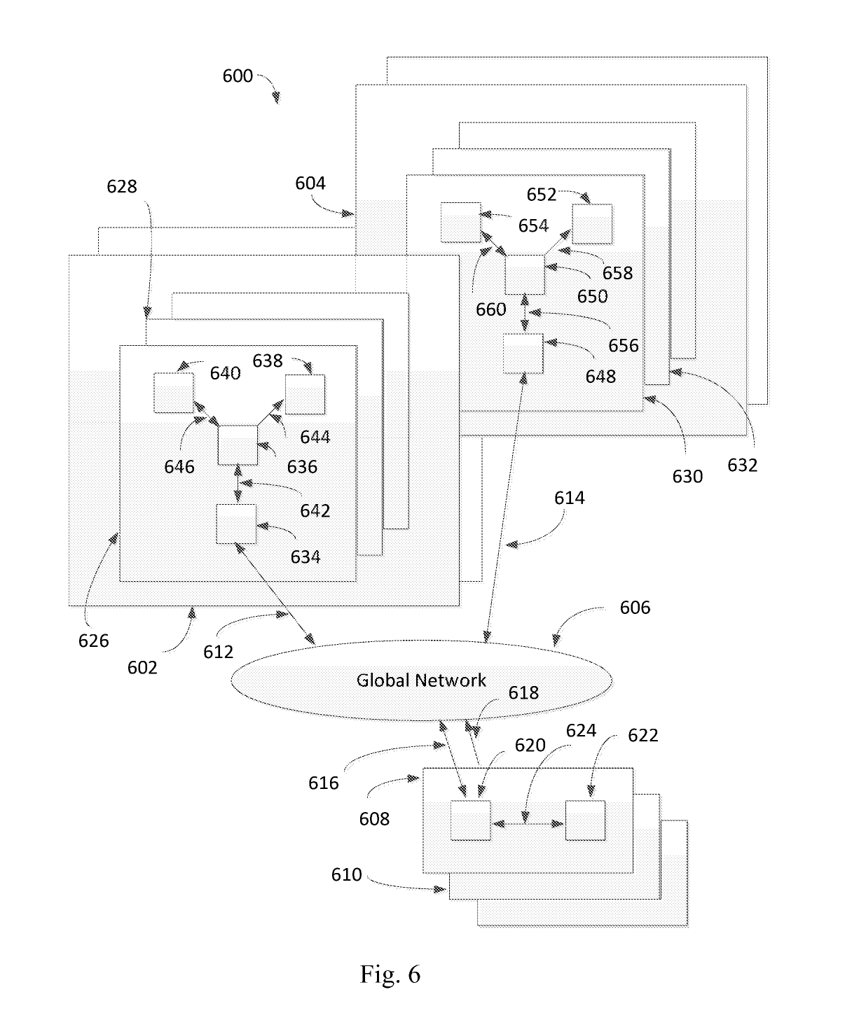

FIG. 6 illustrates a block diagram depicting a conventional client/server communication system.

A communication system 600 includes a multiplicity of networked regions with a sampling of regions denoted as a network region 602 and a network region 604, a global network 606 and a multiplicity of servers with a sampling of servers denoted as a server device 608 and a server device 610.

Network region 602 and network region 604 may operate to represent a network contained within a geographical area or region. Non-limiting examples of representations for the geographical areas for the networked regions may include postal zip codes, telephone area codes, states, counties, cities and countries. Elements within network region 602 and 604 may operate to communicate with external elements within other networked regions or within elements contained within the same network region.

In some implementations, global network 606 may operate as the Internet. It will be understood by those skilled in the art that communication system 600 may take many different forms. Non-limiting examples of forms for communication system 600 include local area networks (LANs), wide area networks (WANs), wired telephone networks, cellular telephone networks or any other network supporting data communication between respective entities via hardwired or wireless communication networks. Global network 606 may operate to transfer information between the various networked elements.

Server device 608 and server device 610 may operate to execute software instructions, store information, support database operations and communicate with other networked elements. Non-limiting examples of software and scripting languages which may be executed on server device 608 and server device 610 include C, C++, C#, Javascript, Typescript, Go and Java.

Network region 602 may operate to communicate bi-directionally with global network 606 via a communication channel 612. Network region 604 may operate to communicate bi-directionally with global network 606 via a communication channel 614. Server device 608 may operate to communicate bi-directionally with global network 606 via a communication channel 616. Server device 610 may operate to communicate bi-directionally with global network 606 via a communication channel 618. Network region 602 and 604, global network 606 and server devices 608 and 610 may operate to communicate with each other and with every other networked device located within communication system 600.

Server device 608 includes a networking device 620 and a server 622. Networking device 620 may operate to communicate bi-directionally with global network 606 via communication channel 616 and with server 622 via a communication channel 624. Server 622 may operate to execute software instructions and store information.

Network region 602 includes a multiplicity of clients with a sampling denoted as a client 626 and a client 628. Client 626 includes a networking device 634, a processor 636, a GUI 638 and an interface device 640. Non-limiting examples of devices for GUI 638 include monitors, televisions, cellular telephones, smartphones and PDAs (Personal Digital Assistants). Non-limiting examples of interface device 640 include pointing device, mouse, trackball, scanner and printer. Networking device 634 may communicate bi-directionally with global network 606 via communication channel 612 and with processor 636 via a communication channel 642. GUI 638 may receive information from processor 636 via a communication channel 644 for presentation to a user for viewing. Interface device 640 may operate to send control information to processor 636 and to receive information from processor 636 via a communication channel 646. Network region 604 includes a multiplicity of clients with a sampling denoted as a client 630 and a client 632. Client 630 includes a networking device 648, a processor 650, a GUI 652 and an interface device 654. Non-limiting examples of devices for GUI 638 include monitors, televisions, cellular telephones, smartphones and PDAs (Personal Digital Assistants). Non-limiting examples of interface device 640 include pointing devices, mousse, trackballs, scanners and printers. Networking device 648 may communicate bi-directionally with global network 606 via communication channel 614 and with processor 650 via a communication channel 656. GUI 652 may receive information from processor 650 via a communication channel 658 for presentation to a user for viewing. Interface device 654 may operate to send control information to processor 650 and to receive information from processor 650 via a communication channel 660.

For example, consider the case where a user interfacing with client 626 may want to execute a networked application. A user may enter the IP (Internet Protocol) address for the networked application using interface device 640. The IP address information may be communicated to processor 636 via communication channel 646. Processor 636 may then communicate the IP address information to networking device 634 via communication channel 642. Networking device 634 may then communicate the IP address information to global network 606 via communication channel 612. Global network 606 may then communicate the IP address information to networking device 620 of server device 608 via communication channel 616. Networking device 620 may then communicate the IP address information to server 622 via communication channel 624. Server 622 may receive the IP address information and after processing the IP address information may communicate return information to networking device 620 via communication channel 624. Networking device 620 may communicate the return information to global network 606 via communication channel 616. Global network 606 may communicate the return information to networking device 634 via communication channel 612. Networking device 634 may communicate the return information to processor 636 via communication channel 642. Processor 666 may communicate the return information to GUI 668 via communication channel 644. User may then view the return information on GUI 638.

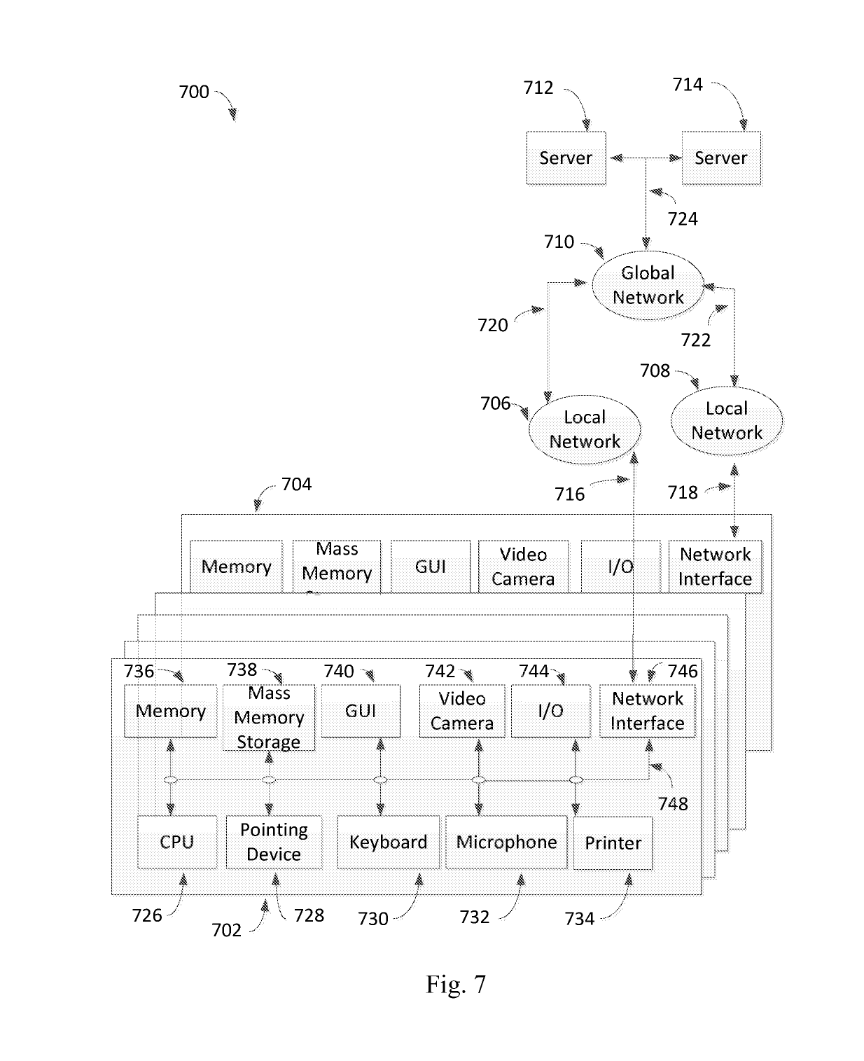

FIG. 7 is a block diagram depicting an exemplary client/server system which may be used by an exemplary web-enabled/networked embodiment of the present invention.

A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones.

Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6).

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing healthcare provider reporting according to the present invention will be apparent to those skilled in the art. Various aspects of the invention have been described above by way of illustration, and the specific embodiments disclosed are not intended to limit the invention to the particular forms disclosed. The particular implementation of the healthcare provider reporting may vary depending upon the particular context or application. By way of example, and not limitation, the healthcare provider reporting described in the foregoing were principally directed to the capture and transmission of encounter codes and quality reporting data using mobile computing devices implementations; however, similar techniques may instead be applied to any customer service encounters, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
displaying an encounter form, the encounter form being at least configured for enabling entry of encounter data obtained during an encounter with a patient by a healthcare provider;
capturing the encounter data;
executing a quality reporting analysis, the quality reporting analysis at least being operable for processing at least a portion of the encounter data with a quality reporting measure data and logic to produce quality measure reporting opportunities for the encounter; and
displaying at least the quality measure reporting opportunities in the encounter form.

2. The method as recited in claim 1, further comprising the step of receiving a quality reporting measure data and logic from a quality measure service.

3. The method as recited in claim 1, further comprising the step of triggering said executing a quality reporting analysis.

4. The method as recited in claim 1, further comprising the step of receiving an encounter form from an encounter form service.

5. The method as recited in claim 1, further comprising the step of transmitting the encounter data to an encounter service.

6. The method as recited in claim 1, further comprising the step of transmitting quality reporting information to a quality reporting service.

7. The method as recited in claim 1, in which the encounter data at least comprises patient identifying information, diagnosis codes, procedure codes, quality reporting data, and healthcare provider identifying information.

8. The method as recited in claim 3, in which said triggering occurs during data entry events in the encounter form.

9. The method as recited in claim 8, in which the data events comprise entry and editing of at least one of: patient identifier and demographic information, diagnosis code, procedure code, and procedure modifier code data.

10. The method as recited in claim 1, in which said displaying displays captured and uncaptured quality measures.

11. The method as recited in claim 10, in which the captured and uncaptured quality measures are visually distinguished.

12. The method as recited in claim 1, in which the portion of the encounter data comprises at least one of: patient gender; patient date of birth; encounter date; procedure codes; diagnosis codes; and quality measure reporting codes.

13. A method comprising:
steps for displaying an encounter form;
steps for capturing encounter data;
steps for executing a quality reporting analysis; and
steps for displaying quality measure reporting opportunities in the encounter form.

14. The method as recited in claim 13, further comprising steps for receiving a quality reporting measure data and logic from a quality measure service.

15. The method as recited in claim 13, further comprising steps for triggering said executing a quality reporting analysis.

16. The method as recited in claim 13, further comprising steps for receiving the encounter form from an encounter form service.

17. The method as recited in claim 13, further comprising steps for transmitting the encounter data to an encounter service.

18. The method as recited in claim 13, further comprising steps for transmitting quality reporting information to a quality reporting service.

19. A non-transitory computer-readable storage medium with an executable program stored thereon, wherein the program instructs one or more processors to perform the following steps:
receiving an encounter form from an encounter form server, the encounter form being at least configured for enabling entry of encounter data obtained during an encounter with a patient by a healthcare provider;
displaying the encounter form;
receiving a quality reporting measure data and logic from a quality measure server;
capturing the encounter data;
triggering a quality reporting analysis, said triggering occurring during data entry events in the encounter form;
executing the quality reporting analysis, the quality reporting analysis at least being operable for processing at least a portion of the encounter data with a quality reporting measure data and logic to produce quality measure reporting opportunities for the encounter; and
displaying at least the quality measure reporting opportunities in the encounter form.

20. The program instructing the one or more processors as recited in claim 19, further comprising the steps of: transmitting the encounter data to an encounter server; and transmitting quality reporting information to a quality reporting server, and wherein the encounter data at least comprises patient identifying information, diagnosis codes, procedure codes, quality reporting data, and healthcare provider identifying information, the data events comprise entry or editing of one or more of: patient identifier and demographic information, diagnosis code, procedure code, and procedure modifier code data, the portion of the encounter data comprises one or more of: patient gender; patient date of birth; encounter date; procedure codes; diagnosis codes; and quality measure reporting codes, said displaying displays captured and uncaptured quality measures, and the captured and uncaptured quality measures are visually distinguished.
